(19) United States
(12) Patent Application Publication
(10) Pub. No.: US 2025/0224378 A1
(43) Pub. Date: Jul. 10, 2025

(54) ENVIRONMENT CONDITION MEASUREMENT DEVICE AND METHOD FOR SETTING ENVIRONMENT CONDITION MEASUREMENT DEVICE

(71) Applicant: DAIKIN INDUSTRIES, LTD., Osaka (JP)

(72) Inventors: Takehiko HIEI, Osaka (JP); Tsuyoshi ISAKA, Osaka (JP); Tomokage ASAKURA, Osaka (JP); Ayane ISHIDA, Osaka (JP)

(21) Appl. No.: 19/087,498

(22) Filed: Mar. 22, 2025

Related U.S. Application Data
(63) Continuation of application No. PCT/JP2023/020149, filed on May 30, 2023.

(30) Foreign Application Priority Data
Sep. 30, 2022 (JP) 2022-157582

(51) Int. Cl. G01N 29/032; G01N 29/22; G01W 1/04

(52) U.S. Cl. CPC G01N 29/032; G01N 29/222; G01N 29/223; G01N 2291/011; G01N 2291/015; G01N 2291/0215; G01N 2291/02881; G01N 2291/105; G01W 1/04

(57) ABSTRACT

An environment condition measurement device includes a plurality of sound wave units installed on a periphery of a measurement target space. The sound wave units are located on a perimeter of a plurality of boundary planes virtually defining the target space. The sound wave units include a transmission unit to transmit a sound wave directionally and a reception unit to receive a sound wave directionally. The measurement device measures an environment condition in the target space based on propagation characteristics of the sound wave that propagates between the transmission and reception units. At least one of the sound wave units is installed in an orientation in which a directivity axis exhibiting a maximum intensity of a directivity of transmission or reception is inclined at a predetermined angle relative to at least one of the boundary planes at which the at least one of the sound wave units is located.

### CROSS-REFERENCE TO RELATED APPLICATIONS

This is a continuation of International Application No. PCT/JP2023/020149 filed on May 30, 2023, which claims priority under 35 U.S.C. § 119(a) to Patent Application No. 2022-157582, filed in Japan on Sep. 30, 2022, all of which are hereby expressly incorporated by reference into the present application.

### BACKGROUND

### Technical Field

The present disclosure relates to an environment condition measurement device and a method for setting an environment condition measurement device.

### Background Information

Devices that measure the environment conditions of a space using sound waves have been known in the art. Japanese Unexamined Patent Publication No. 2019-138891 discloses a wind speed distribution measurement device that measures the wind speed distribution in a measurement target space as an example of such an environment condition measurement device. The wind speed distribution measurement device of Japanese Unexamined Patent Publication No. 2019-138891 includes a plurality of transmitters that transmit sound waves, and a plurality of receivers that receive sound waves.

The wind speed distribution measurement device uses a direct sound from a transmitter and a reflected sound that is the reflection of the direct sound reflected on the receiver and reflected again on the transmitter, in order to obtain the propagation time of the sound waves propagating from the transmitter to the receiver for each of propagation paths extending from the transmitters to the receivers. Based on the propagation time of the sound waves, the wind speed between the transmitter and the receiver is calculated.

### SUMMARY

A first aspect of the present disclosure is directed to an environment condition measurement device. The environment condition measurement device of the first aspect includes a plurality of sound wave units installed on a periphery of a measurement target space. The sound wave units are located on a perimeter of each of a plurality of boundary planes virtually defining the measurement target space. The plurality of sound wave units include a transmission unit configured to transmit a sound wave directionally and a reception unit configured to receive a sound wave directionally. The environment condition measurement device is configured to measure an environment condition in the measurement target space based on propagation characteristics of the sound wave that propagates between the transmission unit and the reception unit. At least one or some of the sound wave units are installed in such an orientation in which a directivity axis exhibiting a maximum intensity of a directivity of transmission or reception is inclined at a predetermined angle with respect to at least one of the boundary planes at which the at least one or some of the sound wave units are located.

### BRIEF DESCRIPTION OF THE DRAWINGS

FIG. 1 is a schematic configuration of an environment condition measurement device according to an embodiment.

FIG. 2 is a block diagram of the environment condition measurement device.

FIG. 3 is a perspective view illustrating a schematic configuration of a sound wave unit.

FIG. 4 is a graph showing the frequency characteristics of a transmission element.

FIG. 5 is a chart showing the directional characteristics of the transmission element.

FIG. 6 is a graph showing the frequency characteristics of a reception element.

FIG. 7 is a chart showing the directional characteristics of the reception element.

FIG. 8 is a layout of a plurality of sound wave units for a measurement target space.

FIG. 9 is a plan view illustrating an exemplary state of installation of the plurality of sound wave units and exemplary propagation paths as viewed in a vertical direction. FIG. 9 shows the sound wave units located on the perimeter of an upper boundary plane and the propagation paths, and the sound wave units located on the perimeter of a lower boundary plane and the propagation paths are parenthesized.

FIG. 10 is a first side view illustrating an exemplary state of installation of the plurality of sound wave units and exemplary propagation paths as viewed in one lateral direction. FIG. 10 shows the sound wave units located on the perimeter of a third side boundary plane and the propagation paths, and the sound wave units located on the perimeter of a fourth side boundary plane and the propagation paths are parenthesized.

FIG. 11 is a second side view illustrating an exemplary state of installation of the plurality of sound wave units and exemplary propagation paths as viewed in another lateral direction. FIG. 11 shows the sound wave units located on the perimeter of a fifth side boundary plane and the propagation paths, and the sound wave units located on the perimeter of a sixth side boundary plane and the propagation paths are parenthesized.

FIG. 12 is a third side view illustrating an exemplary state of installation of the plurality of sound wave units and exemplary propagation paths as viewed from the front of a first partitioning perpendicular plane. FIG. 12 shows the sound wave units located on the perimeter of the first partitioning perpendicular plane and the propagation paths.

FIG. 13 is a plan view illustrating an exemplary state of installation of the plurality of sound wave units together with their directivity axes as viewed in the vertical direction. FIG. 13 shows the sound wave units located on the perimeter of the upper boundary plane and the directivity axes, and the sound wave units located on the perimeter of the lower boundary plane and their directivity axes are parenthesized.

FIG. 14 is a first side view illustrating an exemplary state of installation of the plurality of sound wave units together with their directivity axes as viewed in the one lateral direction. FIG. 14 shows the sound wave units located on the perimeter of the third side boundary plane and the directivity axes, and the sound wave units located on the perimeter of the fourth side boundary plane and their directivity axes are parenthesized.

FIG. 15 is a second side view illustrating an exemplary state of installation of the plurality of sound wave units together with their directivity axes as viewed in the another lateral direction. FIG. 15 shows the sound wave units located on the perimeter of a fifth side boundary plane and the directivity axes, and the sound wave units located on the perimeter of a sixth side boundary plane and their directivity axes are parenthesized.

FIG. 16 is a third side view illustrating an exemplary state of installation of the plurality of sound wave units together with their directivity axes as viewed from the front of the first partitioning perpendicular plane. FIG. 16 shows the sound wave units located on the perimeter of the first partitioning perpendicular plane and their directivity axes.

FIG. 17 is a graph showing the distance attenuation characteristics of a sound wave unit.

FIG. 18 is a conceptual diagram for explaining a transmission angle and a reception angle.

FIG. 19 is a table exemplifying the relationship between the installation angle of each sound wave unit and the angular attenuations.

FIG. 20 is a graph exemplifying the relationship between the installation angle of each sound wave unit and the total angular attenuation.

FIG. 21 is a flowchart showing essential steps of a method for setting an environment condition measurement device.

FIG. 22 is a table exemplifying the total attenuation of sound waves through propagation paths relating to a first sound wave unit, observed when the sound wave units are installed at default angles, and related information.

FIG. 23 is a table exemplifying the total attenuation of sound waves through propagation paths of the first sound wave unit, observed after the angle of each sound wave unit is changed, and related information.

FIG. 24 corresponds to FIG. 16, exemplifying how the installation angles of the sound wave units are changed.

FIG. 25 corresponds to FIG. 14, exemplifying how the installation angles of the sound wave units are changed.

FIG. 26 is a schematic configuration of an environment condition measurement device according to a variation.

### DETAILED DESCRIPTION OF EMBODIMENT(S)

Illustrative embodiments will be described below in detail with reference to the drawings. The drawings are used for conceptual description of the technique of the present disclosure. In the drawings, dimensions, ratios, or numbers may be exaggerated or simplified for easier understanding of the technique of the present disclosure.

### EMBODIMENTS

### Configuration of Environment Condition Measurement Device

An environment condition measurement device (1) according to this embodiment measures the environment conditions of a measurement target space (MS) using sound waves. The measurement target space (MS) is set in an indoor space (IS) in, for example, various facilities or houses. The environment conditions include the wind speed and the air temperature in the measurement target space (MS). An air treatment system may be placed in the indoor space (IS). The air treatment system is, for example, a ventilation system, an air cleaner, and an air conditioner.

### Measurement Target Space

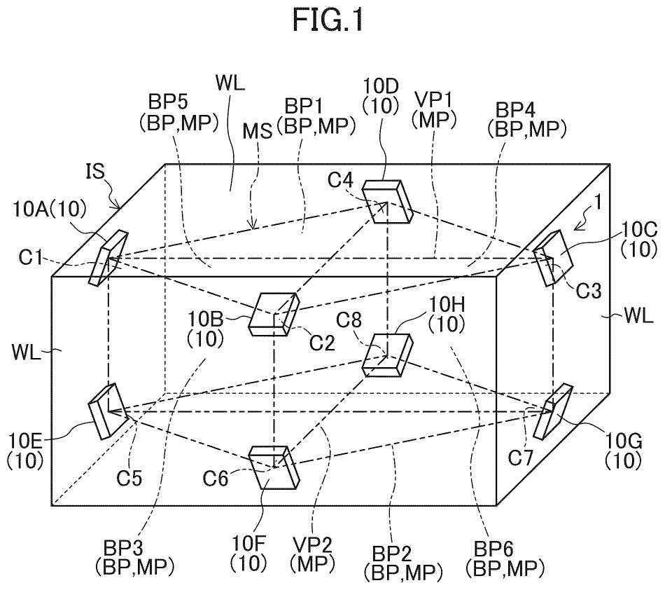

As illustrated in FIG. 1, the measurement target space (MS) is virtually defined by a plurality of boundary planes (BP). The measurement target space (MS) of this example is a three-dimensional space in the shape of a rectangular parallelepiped. The boundary planes (BP) defining this measurement target space (MS) include six boundary planes (BP). The six boundary planes (BP) are an upper boundary plane (BP1), a lower boundary plane (BP2), a first side boundary plane (BP3), a second side boundary plane (BP4), a third side boundary plane (BP5), and a fourth side boundary plane (BP6).

The upper boundary plane (BP1) defines the upper boundary of the measurement target space (MS). The lower boundary plane (BP2) defines the lower boundary of the measurement target space (MS). The upper boundary plane (BP1) and the lower boundary plane (BP2) are rectangular virtual planes spreading in the horizontal direction, and face each other in the up-down direction. The upper boundary plane (BP1) is an example of the first boundary plane, and the lower boundary plane (BP2) is an example of the second boundary plane. The vertices of the upper boundary plane (BP1) are positioned to correspond to the vertices of the lower boundary plane (BP2) in the up-down direction, and overlap with the vertices of the lower boundary plane (BP2) in a plan view.

The first side boundary plane (BP3), the second side boundary plane (BP4), the third side boundary plane (BP5), and the fourth side boundary plane (BP6) are rectangular virtual planes spreading in the vertical direction, and define the peripheral boundaries of the measurement target space (MS). The first side boundary plane (BP3) and the second side boundary plane (BP4) face each other in the horizontal direction. The first side boundary plane (BP3) is an example of the first boundary plane, and the second side boundary plane (BP4) is an example of the second boundary plane. The third side boundary plane (BP5) and the fourth side boundary plane (BP6) form a right angle with the first side boundary plane (BP3) and the second side boundary plane (BP4), and face each other in the horizontal direction. The third side boundary plane (BP5) is an example of the first boundary plane, and the fourth side boundary plane (BP6) is an example of the second boundary plane.

The upper boundary plane (BP1), the first side boundary plane (BP3), and the third side boundary plane (BP5) are adjacent to one another, and share their vertices to form a first corner portion (C1) of the measurement target space (MS). The upper boundary plane (BP1), the first side boundary plane (BP3), and the fourth side boundary plane (BP6) are adjacent to one another, and share their vertices to form a second corner portion (C2). The upper boundary plane (BP1), the second side boundary plane (BP4), and the fourth side boundary plane (BP6) are adjacent to one another, and share their vertices to form a third corner portion (C3) of the measurement target space (MS). The upper boundary plane (BP1), the second side boundary plane (BP4), and the third side boundary plane (BP5) are adjacent to one another, and share their vertices to form a fourth corner portion (C4) of the measurement target space (MS).

The lower boundary plane (BP2), the first side boundary plane (BP3), and the third side boundary plane (BP5) are adjacent to one another, and share their vertices to form a fifth corner portion (C5) of the measurement target space (MS). The lower boundary plane (BP2), the first side boundary plane (BP3), and the fourth side boundary plane (BP6) are adjacent to one another, and share their vertices to form a sixth corner portion (C6). The lower boundary plane (BP2), the second side boundary plane (BP4), and the fourth side boundary plane (BP6) are adjacent to one another, and share their vertices to form a seventh corner portion (C7) of the measurement target space (MS). The lower boundary plane (BP2), the second side boundary plane (BP4), and the third side boundary plane (BP5) are adjacent to one another, and share their vertices to form an eighth corner portion (C8) of the measurement target space (MS).

On the upper boundary plane (BP1), the first corner portion (C1) and the third corner portion (C3) are diagonal to each other, and the second corner portion (C2) and the fourth corner portion (C4) are diagonal to each other. On the lower boundary plane (BP2), the fifth corner portion (C5) and the seventh corner portion (C7) are diagonal to each other, and the sixth corner portion (C6) and the eighth corner portion (C8) are diagonal to each other. The measurement target space (MS) is virtually partitioned by a first partitioning perpendicular plane (VP1) and a second partitioning perpendicular plane (VP2). The first partitioning perpendicular plane (VP1) and the second partitioning perpendicular plane (VP2) are virtual rectangular planes spreading in the vertical direction, and are orthogonal to each other.

The first partitioning perpendicular plane (VP1) is formed by connecting the vertex shared by the upper boundary plane (BP1), the first side boundary plane (BP3), and the third side boundary plane (BP5), the vertex shared by the upper boundary plane (BP1), the second side boundary plane (BP4), and the fourth side boundary plane (BP6), the vertex shared by the lower boundary plane (BP2), the first side boundary plane (BP3), and the third side boundary plane (BP5), and the vertex shared by the lower boundary plane (BP2), the second side boundary plane (BP4), and the fourth side boundary plane (BP6). The first partitioning perpendicular plane (VP1) is set to divide the measurement target space (MS) in one diagonal direction.

The second partitioning perpendicular plane (VP2) is formed by connecting the vertex shared by the upper boundary plane (BP1), the first side boundary plane (BP3), and the fourth side boundary plane (BP6), the vertex shared by the upper boundary plane (BP1), the second side boundary plane (BP4), and the third side boundary plane (BP5), the vertex shared by the lower boundary plane (BP2), the first side boundary plane (BP3), and the fourth side boundary plane (BP6), and the vertex shared by the lower boundary plane (BP2), the second side boundary plane (BP4), and the third side boundary plane (BP5). The second partitioning perpendicular plane (VP2) is set to divide the measurement target space (MS) in another diagonal direction.

The upper boundary plane (BP1), the lower boundary plane (BP2), the first side boundary plane (BP3), the second side boundary plane (BP4), the third side boundary plane (BP5), the fourth side boundary plane (BP6), the first partitioning perpendicular plane (VP1), and the second partitioning perpendicular plane (VP2) in the measurement target space (MS) each form a measurement plane (MP) where the environment conditions are measured.

### Environment Condition Measurement Device

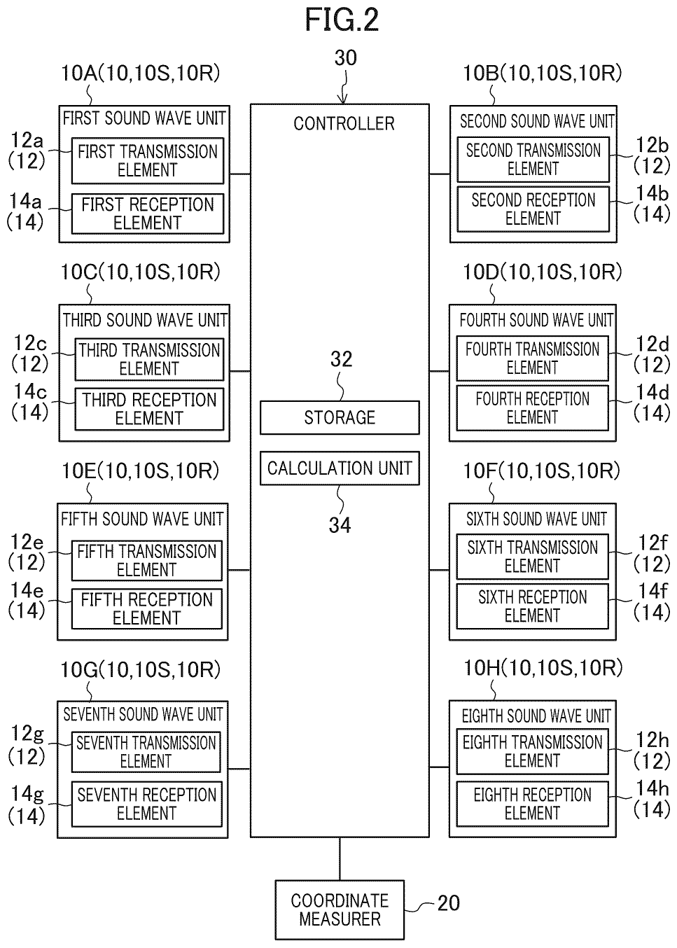

As shown in FIG. 2, the environment condition measurement device (1) includes a plurality of sound wave units (10), a coordinate measurer (20), and a controller (30).

### Sound Wave Unit

The plurality of sound wave units (10) include eight sound wave units (10). The eight sound wave units (10) are a first sound wave unit (10A), a second sound wave unit (10B), a third sound wave unit (10C), a fourth sound wave unit (10D), a fifth sound wave unit (10E), a sixth sound wave unit (10F), a seventh sound wave unit (10G), and an eighth sound wave unit (10H). If it is not necessary to distinguish the first to eighth sound wave units (10A, 10B, 10C, 10D, 10E, 10F, 10G, 10H) from one another, the sound wave units will be simply referred to as the “sound wave units (10).”

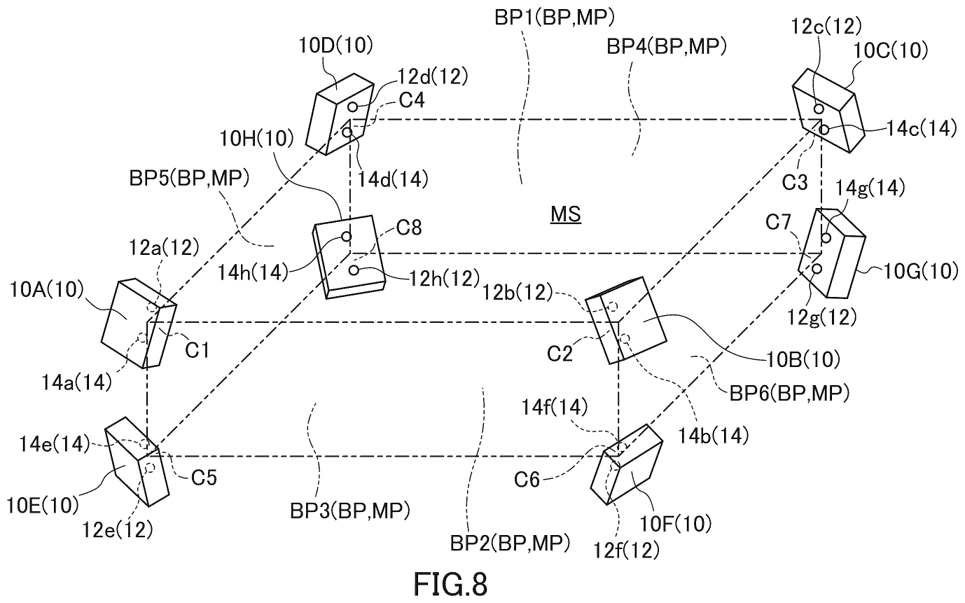

Each of the sound wave units (10) is driven by a built-in battery, and has a wireless communication function, such as a Wi-Fi (registered trademark) or infrared communication. The eight sound wave units (10) are installed at distributed locations spaced apart from one another on the periphery of the measurement target space (MS). The sound wave units (10) are located on the perimeter of each of the six boundary planes (BP). As illustrated in FIG. 8, the sound wave units (10) of this example are arranged at the corner portions of the measurement target space (MS).

Specifically, the first sound wave unit (10A) is located at the first corner portion (C1) of the measurement target space (MS); the second sound wave unit (10B) is located at the second corner portion (C2) of the measurement target space (MS); the third sound wave unit (10C) is located at the third corner portion (C3) of the measurement target space (MS);

the fourth sound wave unit (10D) is located at the fourth corner portion (C4) of the measurement target space (MS); the fifth sound wave unit (10E) is located at the fifth corner portion (C5) of the measurement target space (MS); the sixth sound wave unit (10F) is located at the sixth corner portion (C6) of the measurement target space (MS); the seventh sound wave unit (10G) is located at the seventh corner portion (C7) of the measurement target space (MS); and the eighth sound wave unit (10H) is located at the eighth corner portion (C8) of the measurement target space (MS).

Although not shown, the sound wave units (10) are each supported by a free-standing support. The supports extend in the vertical direction. Each support has a height adjustment mechanism for adjusting the height of the sound wave unit (10) which the support is supporting. For example, the sound wave units (10) arranged at the first to fourth corner portions (C1, C2, C3, C4) are set at the same height by the respective height adjustment mechanisms, and the sound wave units (10) arranged at the fifth to eighth corner portions (C5, C6, C7, C8) are set at the same height by the respective height adjustment mechanisms. Each support further has an angle adjustment mechanism for adjusting the installation angle of the sound wave unit (10). The angle adjustment mechanism is configured to be able to adjust at least the pitch angle and the yaw angle of the sound wave unit (10) among the roll angle, the pitch angle, and the yaw angle of the sound wave unit (10).

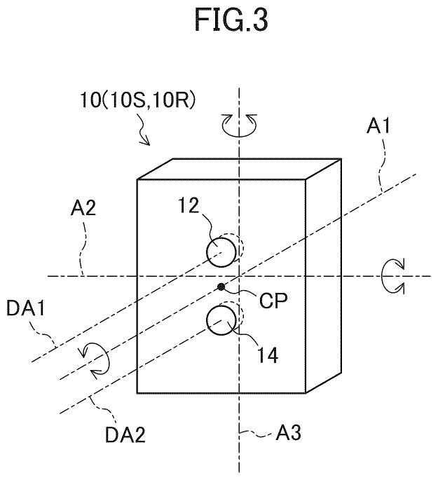

As illustrated in FIG. 3, a roll axis (A1), a pitch axis (A2), and a yaw axis (A3) are defined for each sound wave unit (10). The roll axis (A1) passes through the center of the sound wave unit (10) in the front-back direction. The pitch axis (A2) is orthogonal to the roll axis (A1), and passes through the center of the sound wave unit (10) in the width direction. The yaw axis (A3) is orthogonal to the roll axis (A1) and the pitch axis (A2), and passes through the center of the sound wave unit (10) in the height direction. The installation orientation of each sound wave unit (10) is set by the angle of rotation around the roll axis (A1) (the roll angle), the angle of rotation around the pitch axis (A2) (the pitch angle), and the angle of rotation around the yaw axis (A3) (the yaw angle).

The eight sound wave units (10) include transmission units (10S) that transmit sound waves and reception units (10R) that receive sound waves. Each sound wave unit (10) of this example serves as both a transmission unit (10S) and a reception unit (10R). Each sound wave unit (10) includes a transmission element (12) and a reception element (14) as separate elements. The transmission element (12) and the reception element (14) are positioned at equal distances in a direction along the yaw axis (A3), from the center point (CP) of the front surface of the sound wave unit (10) intersecting with the roll axis (A1) when the sound wave unit (10) is viewed from the front.

The first sound wave unit (10A) includes a first transmission element (12a) and a first reception element (14a). The second sound wave unit (10B) includes a second transmission element (12b) and a second reception element (14b). The third sound wave unit (10C) includes a third transmission element (12c) and a third reception element (14c). The fourth sound wave unit (10D) includes a fourth transmission element (12d) and a fourth reception element (14d). The fifth sound wave unit (10E) includes a fifth transmission element (12e) and a fifth reception element (14e). The sixth sound wave unit (10F) includes a sixth transmission element (12f) and a sixth reception element (14f). The seventh sound wave unit (10G) includes a seventh transmission element (12g) and a seventh reception element (14g). The eighth sound wave unit (10H) includes an eighth transmission element (12h) and an eighth reception element (14h). If it is not necessary to distinguish the first to eighth transmission elements (12a, 12b, 12c, 12d, 12e, 12f, 12g, 12h) from one another, the transmission elements will be simply referred to as the “transmission elements (12).” If it is not necessary to distinguish the first to eighth reception elements (14a, 14b, 14c, 14d, 14e, 14f, 14g, 14h) from one another, the reception elements will be simply referred to as the “reception elements (14).”

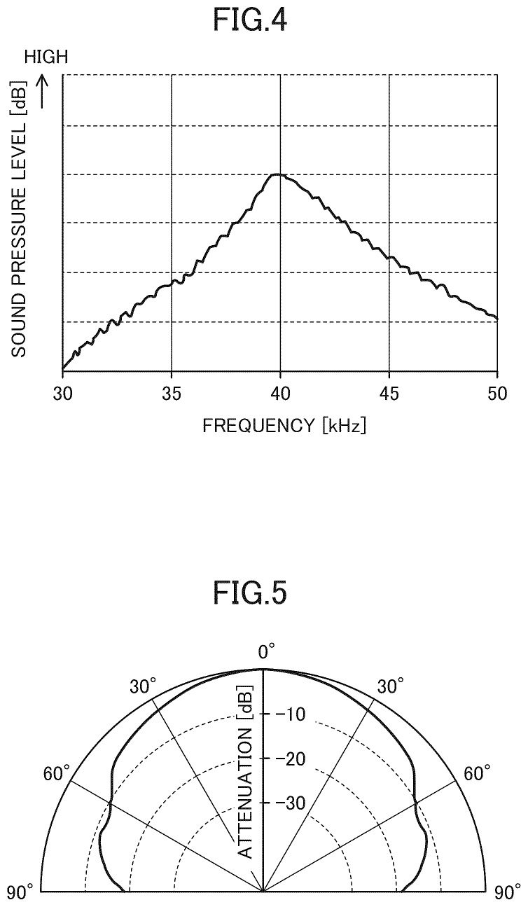

The transmission element (12) implements the function of the transmission unit (10S) (the function of transmitting sound waves). The transmission elements (12) of this example each exhibit such frequency characteristics as shown in FIG. 4: the frequency characteristics have an inverted V-shape, having a peak frequency at 40 kHz and lower sound pressure level toward lower frequencies and higher frequencies from the peak frequency. The transmission elements (12) are configured to be directional. The directional transmission elements (12) directionally transmit sound waves only in a predetermined angular range. The transmission elements (12) of this example have such directional characteristics as illustrated in FIG. 5.

FIG. 5 shows the relationship between the radiation angle of the sound waves transmitted by each transmission element (12) and the transmission intensity at each radiation angle. The transmission intensity of the sound waves emitted from the transmission element (12) is the maximum when the sound waves are emitted in the direction of the normal) (0°) to a transmission surface where the sound waves are transmitted; and the transmission element (12) exhibits a transmission directivity in which the greater the radiation angle, the lower the transmission intensity (i.e., the attenuation of the sound waves increases). The transmission element (12) has a transmission directivity axis (DA1) exhibiting the maximum intensity (maximum output power) of transmission. For the transmission element (12) of this example, the directional angle is an angular range of about 90° each from the transmission directivity axis (DA1) as the center.

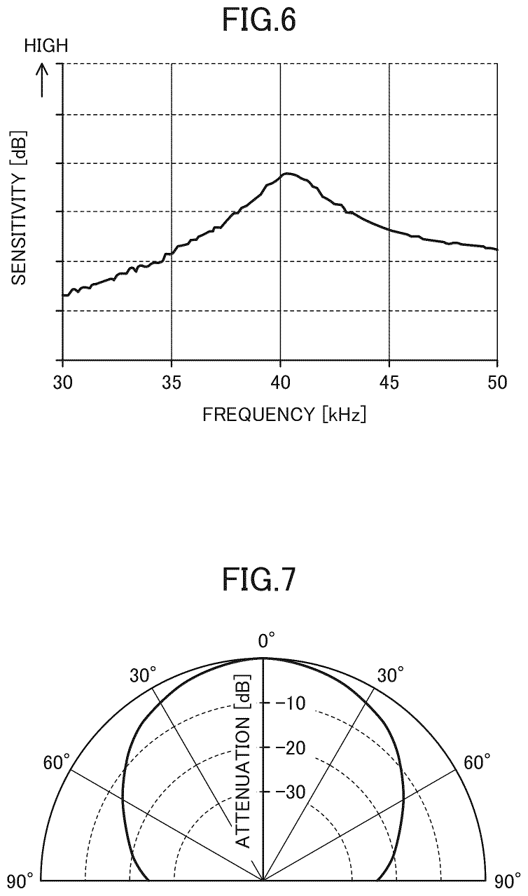

The reception element (14) implements the function of the reception unit (10R) (the function of receiving sound waves). The reception elements (14) of this example each exhibit such frequency characteristics as shown in FIG. 6: the frequency characteristics have an inverted V-shape, having a peak frequency at 40 kHz and lower sensitivity toward lower frequencies and higher frequencies from the peak frequency. The reception elements (14) are configured to be directional. The directional reception elements (14) directionally receive sound waves only in a predetermined angular range. The reception elements (14) of this example have such directional characteristics as illustrated in FIG. 7.

FIG. 7 shows the relationship between the angle of incidence of the sound waves received by each reception element (14) and the receiver sensitivity at each angle of incidence. The receiver sensitivity of the sound waves entering the reception element (14) is the maximum when the sound waves enter from the direction of the normal) (0°) to a receiving surface where the sound waves enter; and the reception element (14) exhibits a reception directivity in which the greater the angle of incidence, the lower the receiver sensitivity (i.e., the attenuation of the sound waves increases). The reception element (14) has a reception directivity axis (DA2) exhibiting the maximum intensity (maximum receiver sensitivity) of reception. For the reception element (14) of this example, the directional angle is an angular range of about 90° each from the reception directivity axis (DA2) as the center.

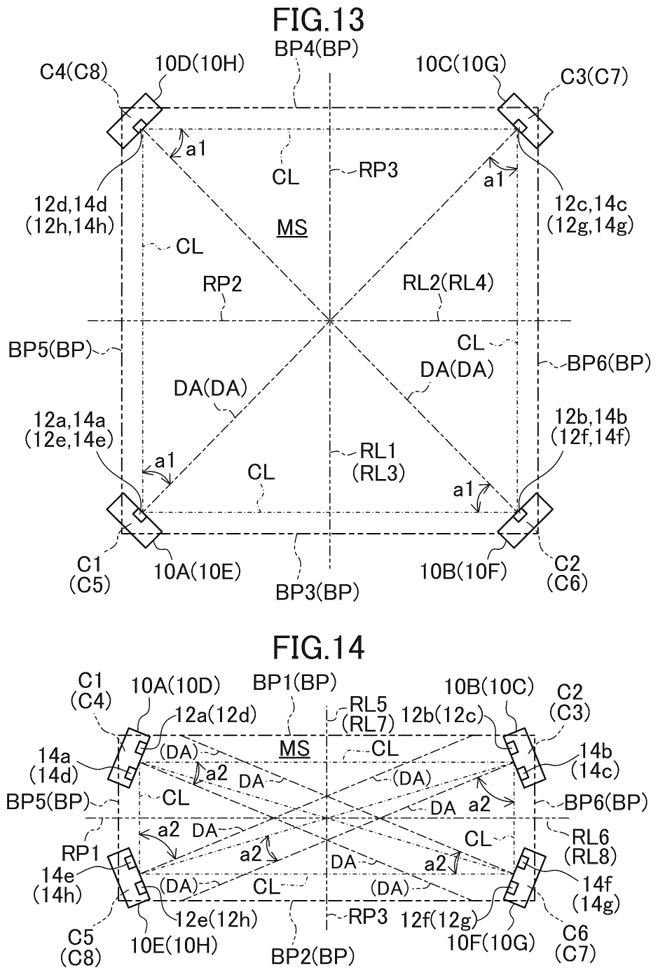

As illustrated in FIG. 3, the transmission surface of the transmission element (12) and the receiving surface of the reception element (14) are on the same surface of each sound wave unit (10). In each sound wave unit (10) of this example, the transmission directivity axis (DA1) and the reception directivity axis (DA2) extend parallel to each other in the same direction. If it is not necessary to distinguish the transmission directivity axis (DA1) and the reception directivity axis (DA2) from each other, the directivity axes will be simply referred to as the “directivity axes (DA).” Each directivity axis (DA) is indicated by one axis line in each of FIGS. 13 to 16 which will be referred to later. Each sound wave unit (10) is installed in such an orientation in which the transmission surface of the transmission element (12) and the receiving surface of the reception element (14) are directed toward the inside of the measurement target space (MS).

The first sound wave unit (10A) transmits and receives sound waves in an area from the first side boundary plane (BP3) to the third side boundary plane (BP5) in a plan view and in an area extending vertically downward from the upper boundary plane (BP1) in a side view. The second sound wave unit (10B) transmits and receives sound waves in an area from the first side boundary plane (BP3) to the fourth side boundary plane (BP6) in a plan view and in an area extending vertically downward from the upper boundary plane (BP1) in a side view. The third sound wave unit (10C) transmits and receives sound waves in an area from the second side boundary plane (BP4) to the fourth side boundary plane (BP6) in a plan view and in an area extending vertically downward from the upper boundary plane (BP1) in a side view. The fourth sound wave unit (10D) transmits and receives sound waves in an area from the second side boundary plane (BP4) to the third side boundary plane (BP5) in a plan view and in an area extending vertically downward from the upper boundary plane (BP1) in a side view.

The fifth sound wave unit (10E) transmits and receives sound waves in an area from the first side boundary plane (BP3) to the third side boundary plane (BP5) in a plan view and in an area extending vertically upward from the lower boundary plane (BP2) in a side view. The sixth sound wave unit (10F) transmits and receives sound waves in an area from the first side boundary plane (BP3) to the fourth side boundary plane (BP6) in a plan view and in an area extending vertically upward from the lower boundary plane (BP2) in a side view. The seventh sound wave unit (10G) transmits and receives sound waves in an area from the second side boundary plane (BP4) to the fourth side boundary plane (BP6) in a plan view and in an area extending vertically upward from the lower boundary plane (BP2) in a side view. The eighth sound wave unit (10H) transmits and receives sound waves in an area from the second side boundary plane (BP4) to the third side boundary plane (BP5) in a plan view and in an area extending vertically upward from the lower boundary plane (BP2) in a side view.

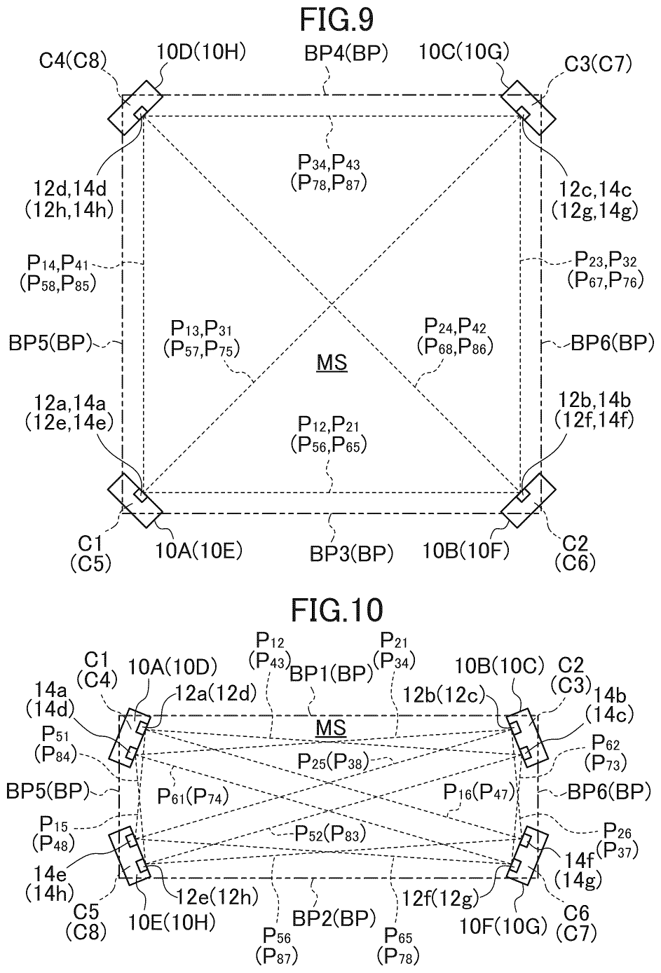

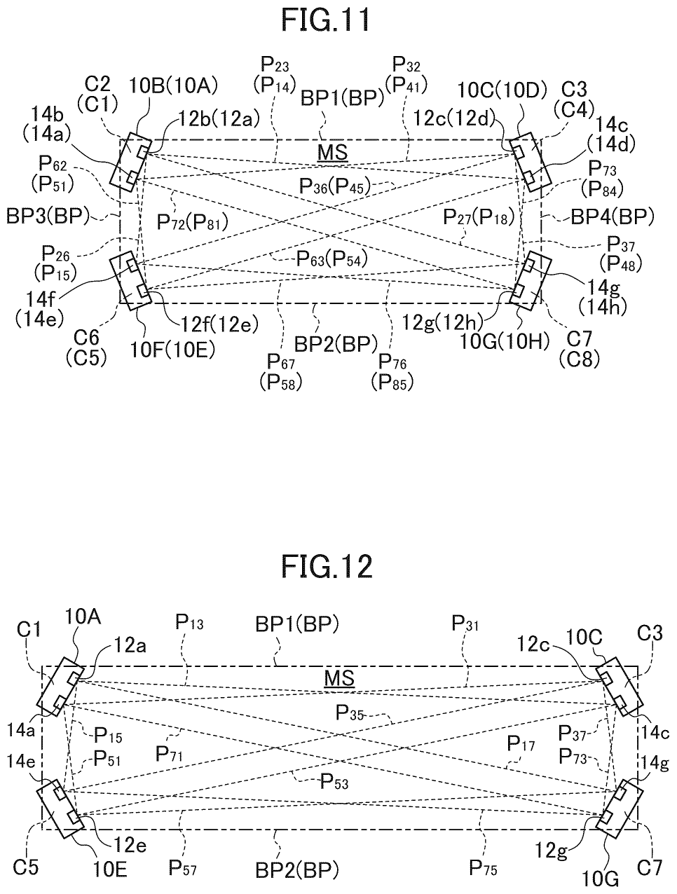

As illustrated in FIGS. 9 to 12, for the plurality of sound wave units (10), a plurality of propagation paths (Pmn) are formed between one sound wave unit (10) and another, wherein m is 1, 2, . . . , and 8 and corresponds to the ordinal number identifying a transmission element (12) and n is 1, 2, . . . , and 8 and corresponds to the ordinal number identifying a reception element (14). If it is not necessary to identify between which pair of sound wave units (10) the propagation path (Pmn) is formed, the propagation paths will be hereinafter simply referred to as the “propagation paths (P).”

There are two propagation paths (P) between a pair of sound wave units (10) performing transmission and reception. These two propagation paths (P) are a propagation path (P) formed between the transmission element (12) of one sound wave units (10) and the reception element (14) of the other sound wave unit (10), and a propagation path (P) formed between the reception element (14) of the one sound wave units (10) and the transmission element (12) of the other sound wave unit (10). In the measurement target space (MS) of this example, 56 propagation paths (P) are formed.

All the 56 propagation paths (P) are propagation paths propagating direct waves. The direct waves are sound waves that are transmitted from one of the pair of the sound wave units (10) associated with the propagation paths (P) and then reach the other sound wave unit (10) without colliding with anything such as a wall surface (WL) of the indoor space (MS). In the measurement target space (MS), a propagation path propagating reflected waves may be formed between the pair of the sound wave units (10). The reflected waves are sound waves that are transmitted from one of the pair of the sound wave units (10) associated with the propagation paths (P) and then reach the other sound wave unit (10) after being reflected from a wall surface (WL) of the indoor space (MS).

Each sound wave unit (10) is installed in such an orientation in which the directivity axis (DA) is inclined at a predetermined angle with respect to at least one boundary plane (BP) on the perimeter of which the sound wave unit (10) is located. Each sound wave unit (10) of this example is installed in such an orientation in which the directivity axis (DA) is inclined at a predetermined angle with respect to each of the three boundary planes (BP) forming the corner portion of the measurement target space (MS) at which the sound wave unit (10) is located. The installation angle of the sound wave unit (10) can be adjusted at least in terms of the pitch angle and the yaw angle by an angle adjusting mechanism for a support that supports the sound wave unit (10).

The first sound wave unit (10A) is installed in such an orientation in which its directivity axis (DA) is inclined with respect to the upper boundary plane (BP1), the first side boundary plane (BP3), and the third side boundary plane (BP5). The second sound wave unit (10B) is installed in such an orientation in which its directivity axis (DA) is inclined with respect to the upper boundary plane (BP1), the first side boundary plane (BP3), and the fourth side boundary plane (BP6). The third sound wave unit (10C) is installed in such an orientation in which its directivity axis (DA) is inclined with respect to the upper boundary plane (BP1), the second side boundary plane (BP4), and the fourth side boundary plane (BP6). The fourth sound wave unit (10D) is installed in such an orientation in which its directivity axis (DA) is inclined with respect to the upper boundary plane (BP1), the second side boundary plane (BP4), and the third side boundary plane (BP5).

The fifth sound wave unit (10E) is installed in such an orientation in which its directivity axis (DA) is inclined with respect to the lower boundary plane (BP2), the first side boundary plane (BP3), and the third side boundary plane (BP5). The sixth sound wave unit (10F) is installed in such an orientation in which its directivity axis (DA) is inclined with respect to the lower boundary plane (BP2), the first side boundary plane (BP3), and the fourth side boundary plane (BP6). The seventh sound wave unit (10G) is installed in such an orientation in which its directivity axis (DA) is inclined with respect to the lower boundary plane (BP2), the second side boundary plane (BP4), and the fourth side boundary plane (BP6). The eighth sound wave unit (10H) is installed in such an orientation in which its directivity axis (DA) is inclined with respect to the lower boundary plane (BP2), the second side boundary plane (BP4), and the third side boundary plane (BP5).

In the environment condition measurement device (1) of this example, the installation orientation of each of the first to eighth sound wave units (10A, 10B, 10C, 10D, 10E, 10F, 10G, 10H) is subject to first to third constraints, which will be described below.

### (1) First Constraint

As illustrated in FIGS. 13 to 16, the angles of the directivity axes (DA) of the four sound wave units (10) located on the perimeter of the same boundary plane (BP) with respect to the same boundary plane (BP) are set to be a same angle.

Specifically, the directivity axes (DA) of the first sound wave unit (10A), the second sound wave unit (10B), the third sound wave unit (10C), and the fourth sound wave unit (10D) form the same angle with respect to the upper boundary plane (BP1). The directivity axes (DA) of the fifth sound wave unit (10E), the sixth sound wave unit (10F), the seventh sound wave unit (10G), and the eighth sound wave unit (10H) form the same angle with respect to the lower boundary plane (BP2). The directivity axes (DA) of the first sound wave unit (10A), the second sound wave unit (10B), the fifth sound wave unit (10E), and the sixth sound wave unit (10F) form the same angle with respect to the first side boundary plane (BP3).

The directivity axes (DA) of the third sound wave unit (10C), the fourth sound wave unit (10D), the seventh sound wave unit (10G), and the eighth sound wave unit (10H) form the same angle with respect to the second side boundary plane (BP4). The directivity axes (DA) of the first sound wave unit (10A), the fourth sound wave unit (10D), the fifth sound wave unit (10E), and the eighth sound wave unit (10H) form the same angle with respect to the third side boundary plane (BP5). The directivity axes (DA) of the second sound wave unit (10B), the third sound wave unit (10C), the sixth sound wave unit (10F), and the seventh sound wave unit (10G) form the same angle with respect to the fourth side boundary plane (BP6).

### (2) Second Constraint

As illustrated in FIGS. 13 to 15, a pair of sound wave units (10) located at adjacent corner portions of the measurement target space (MS) on the perimeter of the same boundary plane (BP) are installed in an orientation in line symmetry with respect to a virtual reference line (RL1 to RL12) passing through an intermediate position between the pair of sound wave units (10) as viewed in a direction orthogonal to the boundary plane (BP).

As illustrated in FIG. 13, the installation orientations of the first sound wave unit (10A) and the second sound wave unit (10B) are line symmetric to each other and the installation orientations of the third sound wave unit (10C) and the fourth sound wave unit (10D) are line symmetric to each other, with respect to a virtual reference line (RL1) passing through the intermediate position of the first and second sound wave units and the intermediate position of the third and fourth sound wave units as viewed in the direction orthogonal to the upper boundary plane (BP1). The installation orientations of the first sound wave unit (10A) and the fourth sound wave unit (10D) are line symmetric to each other and the installation orientations of the second sound wave unit (10B) and the third sound wave unit (10C) are line symmetric to each other, with respect to a virtual reference line (RL2) passing through the intermediate position of the first and fourth sound wave units and the intermediate position of the second and third sound wave units as viewed in the direction orthogonal to the upper boundary plane (BP1).

As parenthesized in FIG. 13, the installation orientations of the fifth sound wave unit (10E) and the sixth sound wave unit (10F) are line symmetric to each other and the installation orientations of the seventh sound wave unit (10G) and the eighth sound wave unit (10H) are line symmetric to each other, with respect to a virtual reference line (RL3) passing through the intermediate position of the fifth and sixth sound wave units and the intermediate positions of the seventh and eighth sound wave units as viewed in the direction orthogonal to the lower boundary plane (BP2). The installation orientations of the fifth sound wave unit (10E) and the eighth sound wave unit (10H) are line symmetric to each other and the installation orientations of the sixth sound wave unit (10F) and the seventh sound wave unit (10G) are line symmetric to each other, with respect to a virtual reference line (RL4) passing through the intermediate position of the fifth and eighth sound wave units and the intermediate positions of the sixth and seventh sound wave units as viewed in the direction orthogonal to the lower boundary plane (BP2).

As illustrated in FIG. 14, the installation orientations of the first sound wave unit (10A) and the second sound wave unit (10B) are line symmetric to each other and the installation orientations of the fifth sound wave unit (10E) and the sixth sound wave unit (10F) are line symmetric to each other, with respect to a virtual reference line (RL5) passing through the intermediate position of the first and second sound wave units and the intermediate position of the fifth and sixth sound wave units as viewed in the direction orthogonal to the first side boundary plane (BP3). The installation orientations of the first sound wave unit (10A) and the fifth sound wave unit (10E) are line symmetric to each other and the installation orientations of the second sound wave unit (10B) and the sixth sound wave unit (10F) are line symmetric to each other, with respect to a virtual reference line (RL6) passing through the intermediate position of the first and fifth sound wave units and the intermediate position of the second and sixth sound wave units as viewed in the direction orthogonal to the first side boundary plane (BP3).

As parenthesized in FIG. 14, the installation orientations of the third sound wave unit (10C) and the fourth sound wave unit (10D) are line symmetric to each other and the installation orientations of the seventh sound wave unit (10G) and the eighth sound wave unit (10H) are line symmetric to each other, with respect to a virtual reference line (RL7) passing through the intermediate position of the third and fourth sound wave units and the intermediate positions of the seventh and eighth sound wave units as viewed in the direction orthogonal to the second side boundary plane (BP4). The installation orientations of the third sound wave unit (10C) and the seventh sound wave unit (10G) are line symmetric to each other and the installation orientations of the fourth sound wave unit (10D) and the eighth sound wave unit (10H) are line symmetric to each other, with respect to a virtual reference line (RL8) passing through the intermediate position of the third and seventh sound wave units and the intermediate positions of the fourth and eighth sound wave units as viewed in the direction orthogonal to the second side boundary plane (BP4).

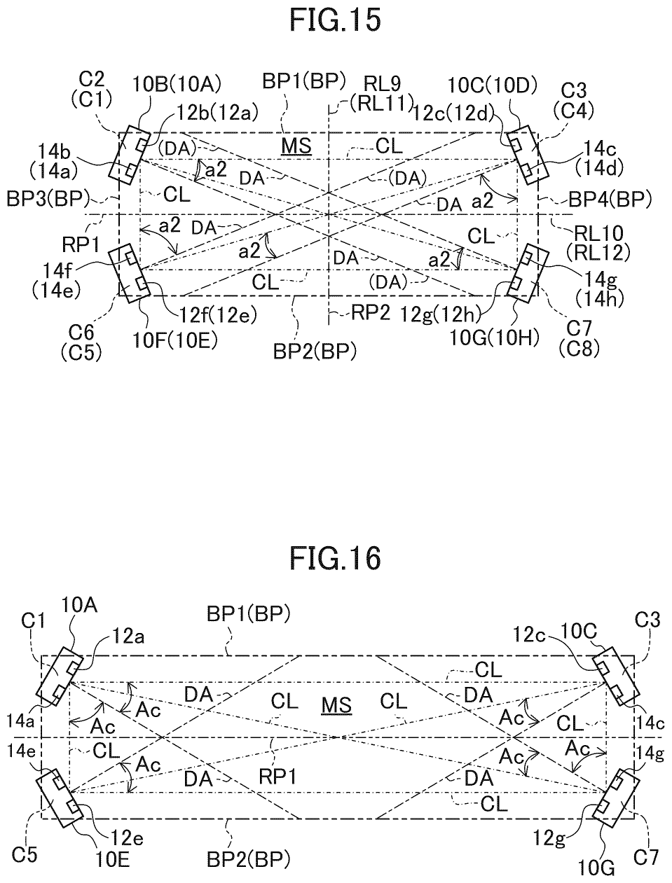

As illustrated in FIG. 15, the installation orientations of the second sound wave unit (10B) and the third sound wave unit (10C) are line symmetric to each other and the installation orientations of the sixth sound wave unit (10F) and the seventh sound wave unit (10G) are line symmetric to each other, with respect to a virtual reference line (RL9) passing through the intermediate position of the second and third sound wave units and the intermediate position of the sixth and seventh sound wave units as viewed in the direction orthogonal to the fourth side boundary plane (BP6). The installation orientations of the second sound wave unit (10B) and the sixth sound wave unit (10F) are line symmetric to each other and the installation orientations of the third sound wave unit (10C) and the seventh sound wave unit (10G) are line symmetric to each other, with respect to a virtual reference line (RL10) passing through the intermediate position of the second and sixth sound wave units and the intermediate position of the third and seventh sound wave units as viewed in the direction orthogonal to the fourth side boundary plane (BP6).

As parenthesized in FIG. 15, the installation orientations of the first sound wave unit (10A) and the fourth sound wave unit (10D) are line symmetric to each other and the installation orientations of the fifth sound wave unit (10E) and the eighth sound wave unit (10H) are line symmetric to each other, with respect to a virtual reference line (RL11) passing through the intermediate position of the first and fourth sound wave units and the intermediate positions of the fifth and eighth sound wave units as viewed in the direction orthogonal to the third side boundary plane (BP5). The installation orientations of the first sound wave unit (10A) and the fifth sound wave unit (10E) are line symmetric to each other and the installation orientations of the fourth sound wave unit (10D) and the eighth sound wave unit (10H) are line symmetric to each other, with respect to a virtual reference line (RL12) passing through the intermediate position of the first and fifth sound wave units and the intermediate positions of the fourth and eighth sound wave units as viewed in the direction orthogonal to the third side boundary plane (BP5).

### (3) Third Constraint

As illustrated in FIGS. 13 to 16, a pair of sound wave units (10) located at positions corresponding to each other on the perimeters of two boundary planes (BP) facing each other are installed in orientations so that the positional relationship of the transmission element (12) and the reception element (14) to a virtual reference plane (RP1 to RP3) defined at the intermediate position between these two boundary planes (BP) is the same.

These installation orientations of the pair of sound wave units (10) are reversed orientations in which the directions of inclination of the pitch angles of the sound wave units (10) are opposite with respect to the reference plane (RP1 to RP3). In this example, the installation orientations of the pair of sound wave units (10) are such that the transmission elements (12) are relatively far from the reference plane (RP1 to RP3) and the reception elements (14) are relatively close to the reference plane (RP1 to RP3). The installation orientations of the pair of sound wave units (10) may be such that the transmission elements (12) are relatively close to the reference plane (RP1 to RP3), and the reception elements (14) are relatively far from the reference plane (RP1 to RP3).

The first sound wave unit (10A) and the fifth sound wave unit (10E), the second sound wave unit (10B) and the sixth sound wave unit (10F), the third sound wave unit (10C) and the seventh sound wave unit (10G), and the fourth sound wave unit (10D) and the eighth sound wave unit (10H) respectively take the above-described reversed orientations with respect to the reference plane (RP1). The first sound wave unit (10A) and the fourth sound wave unit (10D), the second sound wave unit (10B) and the third sound wave unit (10C), the fifth sound wave unit (10E) and the eighth sound wave unit (10H), and the sixth sound wave unit (10F) and the seventh sound wave unit (10G) respectively take the above-described reversed orientations with respect to the reference plane (RP2). The first sound wave unit (10A) and the second sound wave unit (10B), the fourth sound wave unit (10D) and the third sound wave unit (10C), the fifth sound wave unit (10E) and the sixth sound wave unit (10F), and the eighth sound wave unit (10H) and the seventh sound wave unit (10G) respectively take the above-described reversed orientations with respect to the reference plane (RP3).

As described above, since the installation orientations of the first to eighth sound wave units (10A, 10B, 10C, 10D, 10E, 10F, 10G, 10H) are subject to the constraints, the propagation distances, which is the lengths of two propagation paths (P) formed between a pair of sound wave units (10) performing transmission and reception, are equal to each other. The propagation distance is the direct distance between the transmission element (12) and the reception element (14) performing transmission and reception of sound waves.

For example, as for the propagation paths (P) associated with the first sound wave unit (10A), the propagation distances of the two propagation paths (P12, P21) formed between the first sound wave unit (10A) and the second sound wave unit (10B) are equal to each other; the propagation distances of the two propagation paths (P13, P31) formed between the first sound wave unit (10A) and the third sound wave unit (10C) are equal to each other; the propagation distances of the two propagation paths (P14, P41) formed between the first sound wave unit (10A) and the fourth sound wave unit (10D) are equal to each other; the propagation distances of the two propagation paths (P15, P51) formed between the first sound wave unit (10A) and the fifth sound wave unit (10E) are equal to each other; the propagation distances of the two propagation paths (P16, P61) formed between the first sound wave unit (10A) and the sixth sound wave unit (10F) are equal to each other; the propagation distances of the two propagation paths (P17, P71) formed between the first sound wave unit (10A) and the seventh sound wave unit (10G) are equal to each other; and the propagation distances of the two propagation paths (P18, P81) formed between the first sound wave unit (10A) and the eighth sound wave unit (10H) are equal to each other. The propagation distance is the same as the distance between the pair of the sound wave units (10) (strictly speaking, the distance between the center points (CP) of the pair of the sound wave units (10)). The same statement applies to the propagation paths (Pmn) associated with the other sound wave units, i.e., the second to eighth sound wave units (10B, 10C, 10D, 10E, 10F, 10G, 10H).

The installation angle of each sound wave unit (10) is set based on the sound wave attenuation in each of the propagation paths (P) of the sound wave unit (10). The attenuation of the sound waves refers to the sound pressure level that attenuates from when the sound waves are transmitted from one of a pair of sound wave units (10) performing transmission and reception to when the other sound wave unit (10) receives the sound waves. The sound wave attenuation is calculated based on the attenuation due to the directivity of the transmission and the directivity of the reception with respect to the propagation path (P) and the distance attenuation between the pair of sound wave units (10) associated with the propagation path (P).

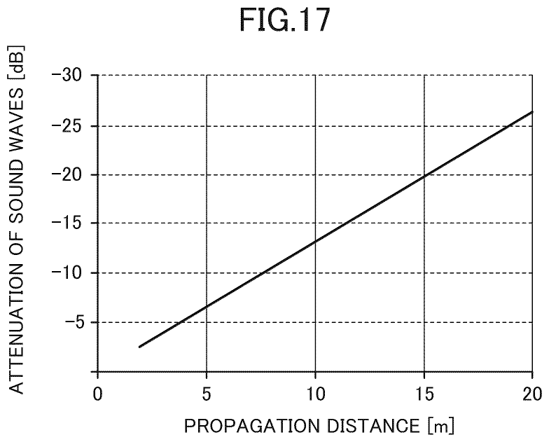

The distance attenuation between the pair of sound wave units (10) refers to the attenuation of sound waves in accordance with the propagation distance of the sound waves. The energy of the sound waves transmitted from a sound wave unit (10) decreases with an increasing distance from the sound wave unit (10), and the sound pressure level decreases by the time when the other sound wave unit (10), paired with the above sound wave unit (10) for transmission and reception, receives the sound waves. As shown in FIG. 17, the sound wave attenuation due to the distance attenuation is determined by the propagation distance of the sound waves, and increases as the propagation distance increases. Thus, the longer the distance between the pair of sound wave units (10) performing transmission and reception, the greater the sound wave attenuation due to the distance attenuation.

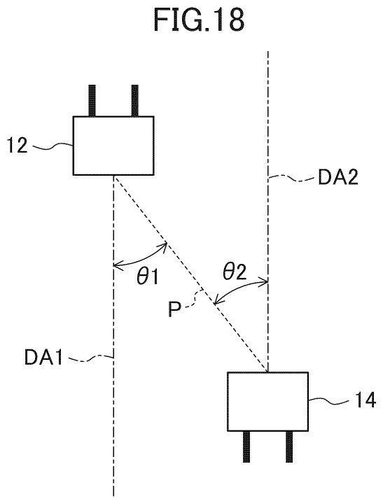

The directivity of transmission through the propagation path (P) is changes in the intensity of radiation of sound waves in accordance with the transmission angle (θ1) of the sound waves. As schematically shown in FIG. 18, the transmission angle (θ1) is an angle formed by the transmission directivity axis (DA1) with respect to the propagation path (P). The sound wave attenuation due to the directivity of transmission is determined based on the directional characteristics of the transmission element (12), and increases as the transmission angle (θ1) increases. The sound wave attenuation due to the directivity of transmission will be hereinafter referred to as the “angular attenuation of the transmission element (12).”

The directivity of reception through each propagation path (P) is changes in the receiver sensitivity of sound waves in accordance with the reception angle (θ2) of the sound waves. As schematically shown in FIG. 18, the reception angle (θ2) is an angle formed by the reception directivity axis (DA2) with respect to the propagation path (P). The sound wave attenuation due to the directivity of reception is determined based on the directional characteristics of the reception element (14), and increases as the reception angle (θ2) increases. The sound wave attenuation due to the directivity of reception will be hereinafter referred to as the “angular attenuation of the reception element (14).”

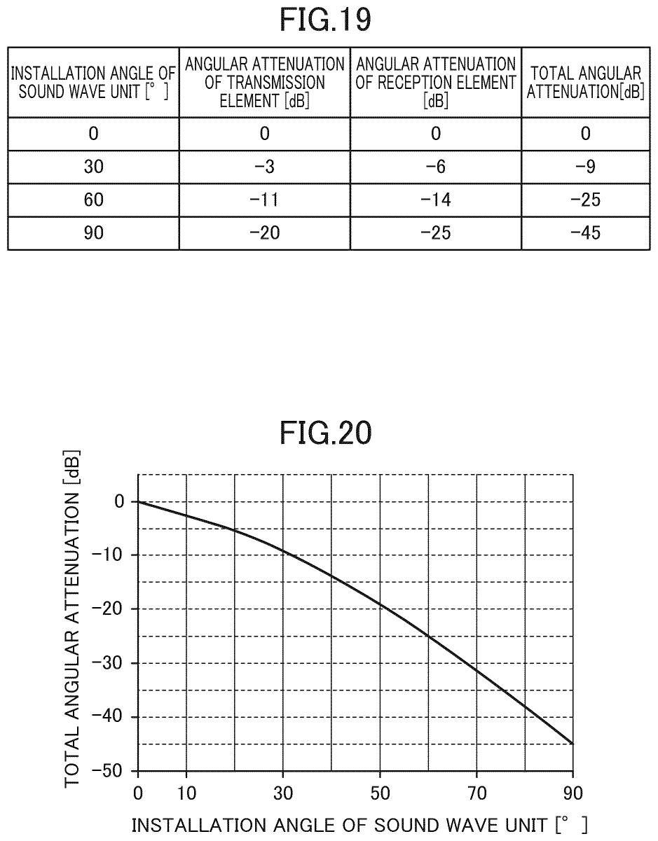

FIG. 19 exemplifies the relationship between the installation angle of the sound wave unit (10) and each of the angular attenuation of the transmission element (12), the angular attenuation of the reception elements (14), and the total angular attenuation. Here, the installation angle of the sound wave unit (10) is an angle formed by the directivity axis (DA) of each of the pair of sound wave units (10) performing transmission and reception with respect to the propagation path (P). The total angular attenuation means the total of the angular attenuation of the transmission element (12) and the angular attenuation of the reception element (14) through the propagation path (P).

As shown in FIG. 19, the greater the installation angle of the sound wave unit (10), the greater the angular attenuation of each of the transmission element (12) and the reception element (14) becomes. As a result, the total angular attenuation in the propagation path (P) increases as also shown in FIG. 20. FIG. 19 shows a situation where the pair of sound wave units (10) performing transmission and reception have the same installation angle. However, in practice, in the pair of sound wave units (10) performing transmission and reception, the transmission angle (θ1) formed by the transmission directivity axis (DA1) with respect to the propagation path (P) and the reception angle (θ2) formed by the reception directivity axis (DA2) with respect to the propagation path (P) are different from each other.

The attenuation of the sound waves through each propagation path (P) is the total attenuation of the sound waves due to the distance attenuation and the combined angular attenuation. The combined angular attenuation will be described later. This total attenuation is calculated by logarithmic calculation based on the sound wave attenuation due to the distance attenuation and the sound wave attenuation due to the combined angular attenuation. The installation angle of each sound wave unit (10) is set such that the total attenuation of the sound waves through all the propagation paths (P) associated with the sound wave unit (10) is smaller than a predetermined value. Here, the predetermined value is set to be a value that enables effective propagation of sound waves through the propagation paths (P) in all combinations of the pair of sound wave units (10) performing transmission and reception (i.e., a value of the total attenuation that should be reduced to perform effective propagation of the sound waves).

If the measurement target space (MS) is not a cubic or similar shape, there is a possibility that the plurality of sound wave units (10) whose installation orientations are set as described above would not face each other directly in any combinations of the pair of sound wave units (10) performing transmission and reception. The installation orientation of each of the sound wave units (10) is changed in accordance with the installation orientation of any one of the sound wave units (10) under the first to third constraints described above. For example, if the installation angle of the first sound wave unit (10A) is changed, the installation angles of the second to eighth sound wave units (10B, 10C, 10D, 10E, 10F, 10G, 10H) are also changed to satisfy the first to third constraints.

### Coordinate Measurer

The coordinate measurer (20) measures the three-dimensional coordinates relating to the shape of the indoor space (IS) and the three-dimensional coordinates relating to the positions of the sound wave units (10). The coordinate measurer (20) is a three-dimensional laser measuring device.

### Controller

The controller (30) includes a microcomputer mounted on a control board and a memory device (specifically, a semiconductor memory) that stores software for operating the microcomputer. The controller (30) is connected to the sound wave units (10) and the coordinate measurer (20) via wireless or wired communication lines. Part or the entirety of the controller (30) may be provided in the sound wave units (10) or may be provided on a server of a network.

The controller (30) includes a storage (32) and a calculation unit (34). The storage (32) stores the three-dimensional coordinates measured by the coordinate measurer (20). The storage (32) stores a plurality of propagation paths (P) and the propagation distances of these propagation paths (P) in association with each other. The calculation unit (34) measures the propagation time in the pair of sound wave units (10) transmitting and receiving sound waves, from when one sound wave unit (10) transmits sound waves to when the other sound wave unit (10) receives the sound waves. The calculation unit (34) obtains the wind speeds and the air temperatures at the measurement planes (MP) in the measurement target space (MS) by a known technique, based on the data stored in the storage (32) and the propagation times of the sound waves through the respective propagation paths (P).

As described above, the environment condition measurement device (1) measures the environment conditions, such as the wind speeds and the air temperatures in the measurement target space (MS), based on the propagation characteristics (in this example, the propagation time) of sound waves propagating between the pair of sound wave units (10) transmitting and receiving sound waves.

### Method for Setting Environment Condition Measurement Device

A method for setting an environment condition measurement device (1) having the above configuration will be described. In setting the environment condition measurement device (1), a plurality of sound wave units (10) are installed at distributed locations apart from one another. By doing so, a plurality of boundary planes (BP) having the sound wave units (10) on its perimeter are determined, and a measurement target space (MS) is defined by the plurality of boundary planes (BP).

In this method for setting the environment condition measurement device (1), the total attenuation of the sound waves is calculated for each of the propagation paths (P) for sound waves of at least one or some of the sound wave units (10), based on the directivity of transmission and the directivity of reception associated with the propagation path (P) and the distance attenuation between the pair of sound wave units (10) transmitting and receiving sound waves. Then, an angle of inclination of the directivity axis (DA) of the sound wave unit (10) in an installation orientation with respect to the boundary planes (BP) forming a corner portion where the sound wave unit (10) is located is determined based on the total attenuation of the sound waves for each of the propagation paths (P).

The determination of the installation angles of the respective sound wave units (10) is made by the controller (30), based on data on the shape and the size of the measurement target space (MS), which is the measurement target input by an operator, and data on the number and installation locations of the sound wave units (10).

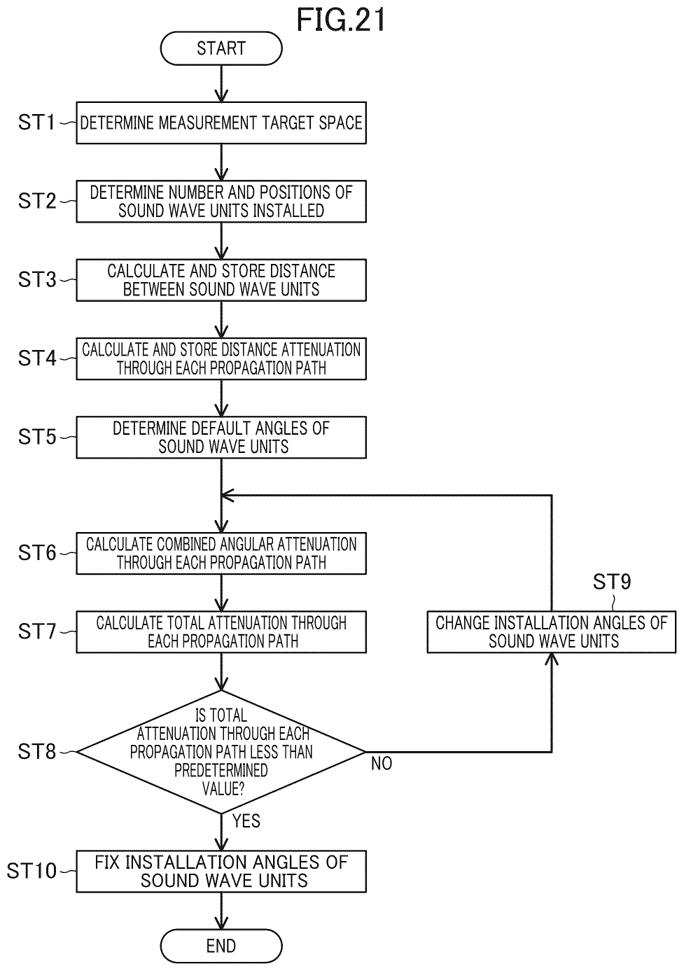

Specifically, as shown in FIG. 21, in step ST1, the operator determines a measurement target space (MS) (the shape and size of the space (MS)) first. In this example, a space of a rectangular parallelepiped shape having the length of 10 m, the width of 10 m, and the height of 2 m is determined to be the measurement target space (MS). The operator enters data on the shape and size of the determined measurement target space (MS) into the controller (30).

Next, in step ST2, the operator determines the number and installation locations of the sound wave units (10) to be installed in the measurement target space (MS) determined in step ST1. In this example, the number of the sound wave units (10) is eight, and the installation locations of the sound wave units (10) are eight corner portions of the measurement target space (MS). The operator enters data on the determined number and installation locations of the sound wave units (10) into the controller (30).

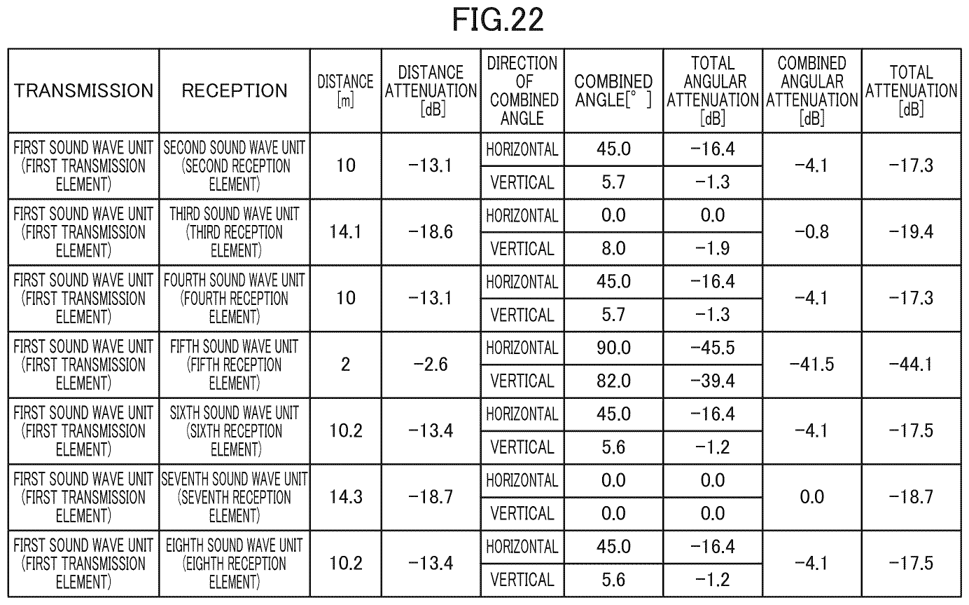

Next, in step ST3, for the plurality of sound wave units (10), the number and installation locations of which are determined in step ST2, the controller (30) calculates the distance between each pair of sound wave units (10) performing transmission and reception. For example, the distance between the first sound wave unit (10A) and each of the second to eighth sound wave units (10B, 10C, 10D, 10E, 10F, 10G, 10H) is calculated as shown in FIG. 22. The storage (32) stores the calculated distances between the sound wave units (10).

Next, in step ST4, using the distance between each pair of sound wave units (10) performing transmission and reception, which is stored in the storage (32), as a propagation distance of the corresponding propagation path (P), the controller (30) calculates the sound wave attenuation due to the distance attenuation for each propagation path (P). For example, the sound wave attenuation due to the distance attenuation for each propagation path (P) between the first sound wave unit (10A) and each of the second to eighth sound wave units (10B, 10C, 10D, 10E, 10F, 10G, 10H) is calculated as shown in FIG. 22. The storage (32) stores the calculated sound wave attenuation due to the distance attenuation in each propagation path (P).

Next, in step ST5, the controller (30) determines the default angle of each sound wave unit (10). The default angle of each sound wave unit (10) in this example is the angle of the sound wave unit (10) in an orientation with its directivity axis (DA) directed toward the center of the measurement target space (MS). Thus, the pair of the sound wave units (10) located on a diagonal line of the measurement target space (MS) face each other directly when the pair is in the orientation at the default angle.

Next, in step ST6, the controller (30) calculates the sound wave attenuation due to the combined angular attenuation in each propagation path (P). The installation angles (the direction of the directivity axes (DA)) of the sound wave units (10) at this moment are already known. In step ST6, the controller (30) first calculates, for each propagation path (P), the transmission angle formed by the transmission directivity axis (DA1) of the sound wave unit (10) with respect to the propagation path (P) and the reception angle formed by the reception directivity axis (DA2) of the sound wave unit (10) with respect to the propagation path (P).

The transmission angle and the reception angle with respect to each propagation path (P) correspond to the combined angle (Ac) of the pair of sound wave units (10) associated with the propagation path (P). As illustrated in FIG. 16, the combined angle (Ac) of the pair of sound wave units (10) is the angles formed by the directivity axes (DA) of the pair of the sound wave units (10) with respect to a combined line (CL) drawn in the middle of the two propagation paths (P) of the sound wave units (10). The combined line (CL) is determined as the line connecting the center points (CP) of the pair of sound wave units (10) performing transmission and reception.

The combined angle (Ac) is the angles of inclination with respect to the horizontal direction and the vertical direction. Thus, the combined angle (Ac) can be handled as the combined angle (a1) in the horizontal direction and the combined angle (a2) in the vertical direction separately as illustrated in FIGS. 13 to 15. The combined angle (a1) in the horizontal direction is the angle between the target directivity axis (DA) and the corresponding combined line (CL) on the horizontal plane as viewed perpendicularly. The combined angle (a2) in the vertical direction is the angle between the target directivity axis (DA) and the corresponding combined line (CL) on the vertical plane as viewed perpendicularly. For example, the combined angle (a1) in the horizontal direction and the combined angle (a2) in the vertical direction between the first sound wave unit (10A) and each of the second to eighth sound wave units (10B, 10C, 10D, 10E, 10F, 10G, 10H) are obtained as shown in FIG. 22.

The controller (30) calculates, for each of the combined angle (a1) in the horizontal direction and the combined angle (a2) in the vertical direction associated with each propagation path (P), the transmission attenuation, which is the sound wave attenuation due to the angular attenuation of the transmission element (12) in the propagation path (P), based on the directional characteristics of the transmission element (12). The controller (30) also calculates, for each of the combined angle (a1) in the horizontal direction and the combined angle (a2) in the vertical direction associated with each propagation path (P), the reception attenuation, which is the sound wave attenuation due to the angular attenuation of the reception element (14) in the propagation path (P), based on the directional characteristics of the reception element (14).

Further, the controller (30) calculates, for the combined angle (al) in the horizontal direction associated with each propagation path (P), the total angular attenuation in the horizontal direction by adding the transmission attenuation and reception attenuation of the sound waves in the propagation path (P). The controller (30) also calculates, for the combined angle (a2) in the vertical direction associated with each propagation path (P), the total angular attenuation in the vertical direction by adding the transmission attenuation and reception attenuation of the sound waves in the propagation path (P).

Then, the controller (30) combines, for each propagation path (P), the total angular attenuation in the horizontal direction and the total angular attenuation in the vertical direction by logarithmic calculation, thereby calculating the sound wave attenuation due to the combined angular attenuation. For example, the total angular attenuation in the horizontal direction, the total angular attenuation in the vertical direction, and the combined angular attenuation for each of the propagation paths (P) between the first sound wave unit (10A) and the second to eighth sound wave units (10B, 10C, 10D, 10E, 10F, 10G, 10H) are calculated as shown in FIG. 22. The storage (32) stores the calculated sound wave attenuation due to the combined angular attenuation in each propagation path (P).

Next, in step ST7, the controller (30) calculates the total attenuation of the sound waves in each propagation path (P) based on the sound wave attenuation due to the distance attenuation in the propagation path (P) and the sound wave attenuation due to the combined angular attenuation in the propagation path (P), which are stored in the storage (32). For example, the total attenuation for each propagation path (P) between the first sound wave unit (10A) and each of the second to eighth sound wave units (10B, 10C, 10D, 10E, 10F, 10G, 10H) is calculated as shown in FIG. 22. The storage (32) stores the calculated total attenuation of the sound waves in each propagation path (P).

Next, in step ST8, the controller (30) determines whether or not the total attenuation of the sound waves in each propagation path (P) stored in the storage (32) is less than a predetermined value. If it is determined in step S8 that the total attenuation of the sound waves in all the propagation paths (P) is less than the predetermined value (in the case of “YES”), the process proceeds to step ST10, in which the installation angles of the sound wave units (10) are fixed and the setting of the installation angles of the sound wave units (10) ends.

On the other hand, if the total attenuation of the sound waves is equal to or greater than the predetermined value in any one of the propagation paths (P) in step ST8, the process proceeds to step ST9. In step ST9, for the propagation path (P) in question, whose total attenuation of the sound waves is equal to or greater than the predetermined value, the installation angles of the sound wave units (10) associated with the propagation path (P) are changed. Here, the installation angle of each of the sound wave units (10) is changed by tilting the directivity axis (DA) of the sound wave unit (10) toward the target propagation path (P).

In step ST9, the installation angles of the sound wave units (10) involved with the sound wave unit (10), a target of change, under the first to third constraints are also changed in accordance with the first to third constraints. In this example, if the installation angle of the sound wave unit (10) associated with one propagation path (P) is changed, the installation angles of all the sound wave units (10) are changed. The installation angle of the sound wave unit (10) may be changed by shifting only a given angle determined beforehand from the default angle, or may be changed by shifting a predetermined angle corresponding to the magnitude of the total attenuation of the sound waves so that the total attenuation of the sound waves of the propagation path (P) in question can be improved.

For example, suppose that the predetermined value serving as a determination criterion in step ST8 is set to 32 dB. In this case, as shown in FIG. 22, among the plurality of sound wave units (10) at default angles, the total attenuation of the sound waves in each of the propagation paths (P) between the first sound wave unit (10A) and the fifth sound wave unit (10E) is equal to or greater than the predetermined value. Similarly, the total attenuation of the sound waves in each of the propagation paths (P) between the second sound wave unit (10B) and the sixth sound wave unit (10F), between the third sound wave unit (10C) and the seventh sound wave unit (10G), and between the fourth sound wave unit (10D) and the eighth sound wave unit (10H), whose positional relationships are similar to the positional relationship between the first sound wave unit (10A) and the fifth sound wave unit (10E), is also equal to or greater than the predetermined value. Thus, the controller (30) determines “NO” in step ST8, and the process proceeds to step ST9.

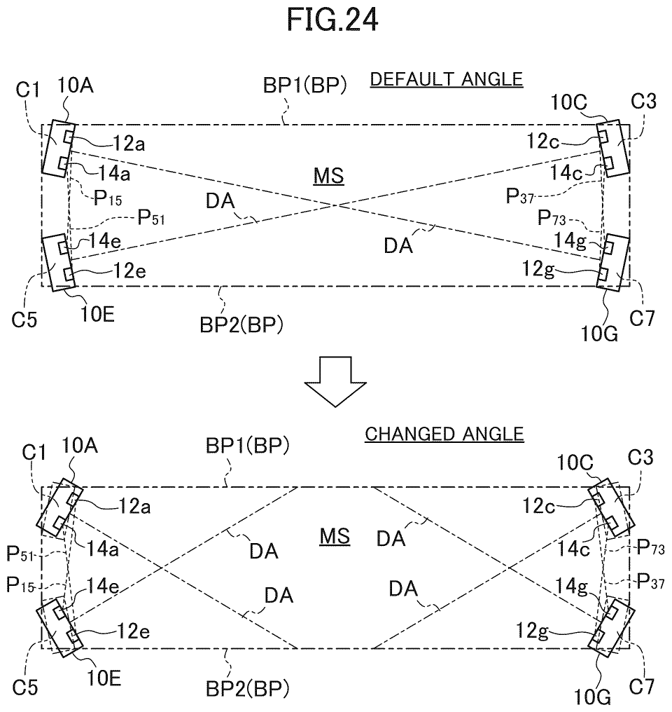

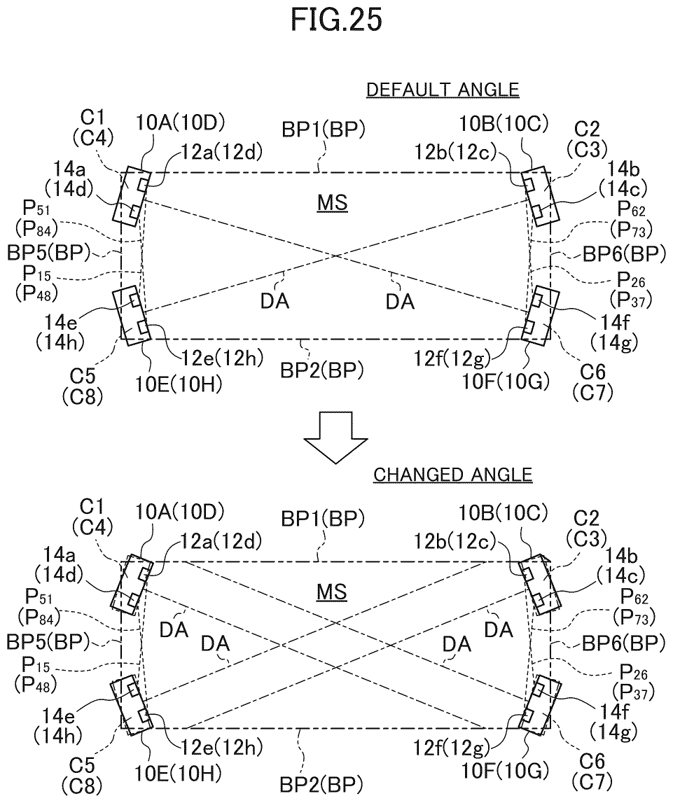

In the example shown in FIG. 22, for example, the installation angles (pitch angles) of the first sound wave unit (10A) and the third sound wave unit (10C) are changed in step ST9 in order to change the combined angle (a2) in the vertical direction between the first sound wave unit (10A) and the third sound wave unit (10C) from 8° to 30°. Thus, as illustrated in FIGS. 24 and 25, the installation orientations of the first sound wave unit (10A) and the fifth sound wave unit (10E), the installation orientations of the second sound wave unit (10B) and the sixth sound wave unit (10F), and the installation orientations of the third sound wave unit (10C) and the seventh sound wave unit (10G) are changed to such orientations in which the directivity axes (DA) of the two sound wave units (10) are inclined toward the propagation paths (P) between the two sound wave units (10) and intersect each other. The same statement applies to the installation orientations of the fourth sound wave unit (10D) and the eighth sound wave unit (10H) (not shown).

After the change in the installation angles of the sound wave units (10) ends in step ST9, the process returns to step ST6, and the subsequent steps ST6, ST7, ST8, and ST9 are performed until the determination criterion in step ST8 is satisfied. If the determination criterion is satisfied in step ST8, the process proceeds to step ST10 as described above, in which the installation angles of the sound wave units (10) are fixed and then the setting of the installation angles of the sound wave units (10) ends.

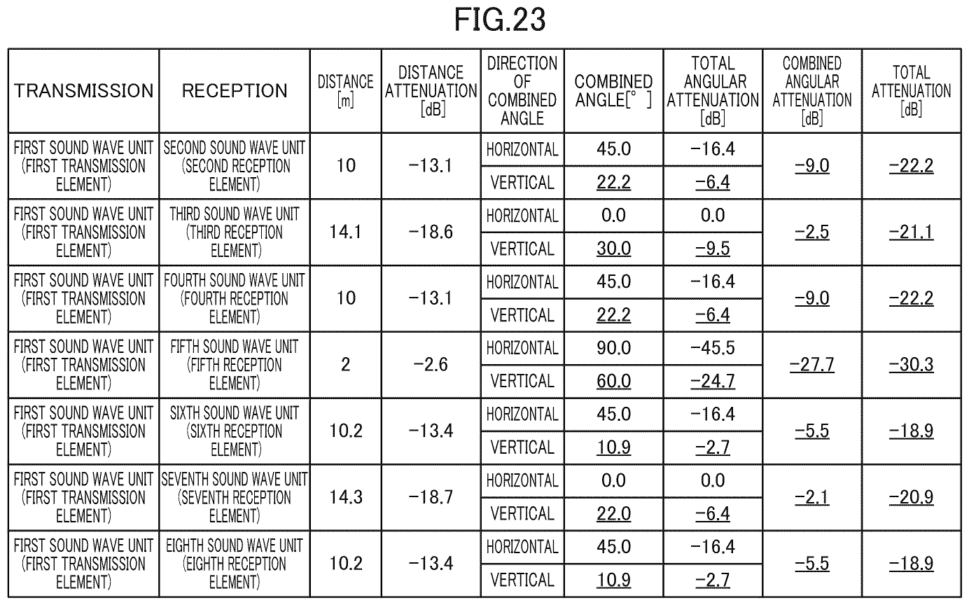

In the example shown in FIG. 22, the combined angles (a2) in the vertical direction between the first sound wave unit (10A) and each of the second to eighth sound wave units (10B, 10C, 10D, 10E, 10F, 10G, 10H) after the changes in the installation angles of the sound wave units (10) are obtained again as underlined in FIG. 23. Then, in steps ST6 and ST7, the sound wave attenuation due to the combined angular attenuation and the total attenuation of the sound waves in each propagation path (P) are calculated again.

The sound wave attenuation due to the combined angular attenuation and the total attenuation in each of the propagation paths (P) between the first sound wave unit (10A) and each of the second to eighth sound wave units (10B, 10C, 10D, 10E, 10F, 10G, 10H) are calculated again as underlined in FIG. 23. In this case, the total attenuation in each of the propagation paths (P) between the first sound wave unit (10A) and the fifth sound wave unit (10E) is −30.3 dB. Thus, the determination result is “YES” in step ST8, and the installation angles of the sound wave units (10) are fixed.

In setting the environment condition measurement device (1), the operator installs the plurality of sound wave units (10) at predetermined distributed locations on the periphery of the measurement target space (MS) in accordance with the installation angles of the sound wave units (10) fixed in the above manner. The setting of the environment condition measurement device (1) may be achieved by adjusting the installation angle of each of the plurality of sound wave units (10) after the sound wave units (10) are temporarily installed at default angles.

### Features of Embodiment

In the environment condition measurement device (1) of this embodiment, the plurality of sound wave units (10) are each installed in a predetermined inclined orientation. The predetermined inclined orientation is an orientation in which the directivity axis (DA) of each sound wave unit (10) is inclined at a predetermined angle with respect to the boundary planes (BP) at which the sound wave unit (10) is located. This allows sound waves to propagate effectively in the propagation paths (P) between a pair of sound wave units (10) not facing each other, thus reducing the loss of data. As a result, it is possible to improve the reliability of the result of measurement performed by the environment condition measurement device (1).

In the environment condition measurement device (1) of this embodiment, the sound wave units (10) located at the corresponding corner portions of the measurement target space (MS) are each installed in the predetermined inclined orientation. The predetermined inclined orientation is an orientation in which the directivity axis (DA) is inclined at a predetermined angle with respect to each of the plurality of boundary planes (BP) forming the corner portion of the measurement target space (MS). This is advantageous in propagating sound waves effectively in the propagation paths (P) between a pair of sound wave units (10) which are arranged three-dimensionally for transmitting and receiving sound waves, and reducing the loss of data.

In the environment condition measurement device (1) of this embodiment, the installation angle of each sound wave unit (10) is set based on the sound wave attenuation in each of the propagation paths (P) of the sound wave unit (10). If the sound wave attenuation in a propagation path (P) is great, sound waves cannot propagate effectively in the propagation path (P). Thus, the installation angles of the sound wave units (10) are determined such that the sound wave attenuation in each propagation path (P) falls within a predetermined range (a range below a predetermined value), so that the sound waves can propagate effectively in the propagation paths (P).

In the environment condition measurement device (1) of this embodiment, the sound wave attenuation is calculated based on the directivity of the transmission and the directivity of the reception with respect to the propagation path (P) and the distance attenuation between the pair of sound wave units (10) associated with the propagation path (P). The sound waves propagating the propagation path (P) attenuate more with less directivity of the transmission with respect to the propagation path (P), attenuate more with less directivity of reception with respect to the propagation path (P), and attenuate more with greater distance attenuation between the pair of sound wave units (10) associated with this propagation path (P). The sound wave attenuation in the propagation path (P) can be accurately calculated if the calculation is based on the directivities of transmission and reception with respect to the propagation path (P) and the distance attenuation associated with the propagation path (P), which are closely relevant to the sound wave attenuation as described above.

In the environment condition measurement device (1) of this embodiment, the installation orientations of the plurality of sound wave units (10) located on the perimeter of the same boundary plane (BP) are determined so that the angles formed by the directivity axes (DA) of the sound wave units (10) with respect to the same boundary plane (BP) are equal to one another. According to this configuration, it is possible to simplify the setting of the installation angles of the plurality of sound wave units (10).

In the environment condition measurement device (1) of this embodiment, the installation orientations of a pair of sound wave units (10) located at adjacent corner portions of the measurement target space (MS) on the perimeter of the same boundary plane (BP) are determined so that the pair of sound wave units (10) are in a line symmetrical relationship with respect to a virtual reference line (RL1 to RL12) passing through an intermediate position between the pair of sound wave units (10) as viewed in a direction orthogonal to the boundary plane (BP). According to this configuration, it is possible to simplify the setting of the installation angles of the plurality of sound wave units (10).

In the environment condition measurement device (1) of this embodiment, each of two sound wave units (10) located at positions corresponding to each other on the perimeters of a pair of boundary planes (BP) facing each other includes the transmission element (12) and the reception element (14) as separate elements. The positional relationship of the transmission element (12) and the reception element (14) of each of the two sound wave units (10) with the virtual reference plane (RP1 to RP3) is the same. It is thus possible to reduce the difference in length between the two propagation paths (P) formed between a pair of the sound wave units (10). This is advantageous in simplifying the measurement performed by the environment condition measurement device (1).

In the method for setting the environment condition measurement device (1) of this embodiment, the sound wave attenuation is calculated for each of the propagation paths (P) for sound waves associated with each sound wave unit (10), based on the directivity of transmission and the directivity of reception associated with the propagation path (P) and the distance attenuation between the pair of sound wave units (10) associated with the propagation path (P). The total attenuation of the sound waves in the propagation path (P) can be accurately calculated if the calculation is based on the directivities of transmission and reception with respect to the propagation path (P) and the distance attenuation associated with the propagation path (P).

In the method for setting the environment condition measurement device (1) of this embodiment, the angle of each sound wave unit (10) in the installation orientation is determined. The installation angle is an angle at which the directivity axis (DA) is inclined with respect to each of the boundary planes (BP) forming the corner portion of the measurement target space (MS) where the sound wave unit (10) is located, and is determined based on the sound wave attenuation for each of the propagation paths (P) associated with the sound wave unit (10). Here, the installation angles of the sound wave units (10) are determined such that the sound wave attenuation in each propagation path (P) falls within a predetermined range (a range below a predetermined value), so that the sound waves can propagate effectively in the propagation paths (P). As a result, it is possible to improve the reliability of the result of measurement performed by the environment condition measurement device (1).

### OTHER EMBODIMENTS

The above-described embodiments may be modified as follows.

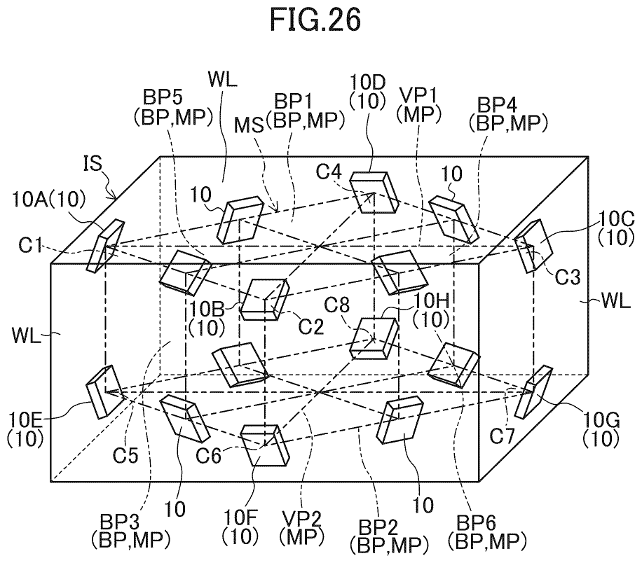

The number of the sound wave units (10) is not limited to eight and may be nine or more. For example, if the resolution of the measurement of the environment conditions at each measurement plane (MP) needs to be increased, the number of the sound wave units (10) located on the perimeter of each measurement plane (MP) is increased as illustrated in FIG. 26. The number of the sound wave units (10) may be equal to or less than seven, and is appropriately changed in accordance with the shape and size of the measurement target space (MS).

Only one or some of the plurality of sound wave units (10) may be installed in an orientation in which the directivity axis (DA) is inclined at a predetermined angle with respect to each of the boundary planes (BP) forming the corner portion of the measurement target space (MS) at which the sound wave unit (10) is located. In short, in order that the sound waves propagate effectively in all the propagation paths (P), it is enough that at least one or some of the sound wave units (10) are installed in such orientations in which the directivity axis (DA) is inclined at the predetermined angle with respect to at least one the boundary plane (BP) at which the sound wave unit (10) is located.

The transmission directivity axis (DA1) and the reception directivity axis (DA2) of the sound wave unit (10) may be oriented in different directions as long as the transmission surface of the transmission element (12) and the receiving surface of the reception element (14) face toward the inside of the measurement target space (MS). In this case, the sound wave unit (10) is installed in such an orientation in which the transmission directivity axis (DA1) or the reception directivity axis (DA2) is inclined with respect to at least one boundary plane (BP) at which the sound wave unit (10) is located.

The sound wave unit (10) may include an integrated transmitting and reception element having the functions of both the transmission element (12) and the reception element (14) without including the transmission element (12) and the reception element (14) as separate elements.

The plurality of sound wave units (10) may include a transmission unit (10S) and a reception unit (10R) as separate units. For example, the plurality of sound wave units (10) may include a plurality of transmission units (10S) having only the transmission function and a plurality of reception units (10R) having only the reception function.

The plurality of sound wave units (10) may include a sound wave unit (10) serving as both the transmission unit (10S) and the reception unit (10R), a sound wave unit (10) functioning only as the transmission unit (10S), and a sound wave unit (10) functioning only as the reception unit (10R) together.

The environment condition measurement device (1) may measure the environment conditions other than the wind speed and the air temperature in the measurement target space (MS). For example, the environment condition measurement device (1) may measure, as an environment condition, the air pressure in the measurement target space (MS).

In the environment condition measurement device (1), the installation orientations of the plurality of sound wave units (10) may be without at least one of the first to third constraints. The installation orientations of the sound wave units (10) may be separately and independently determined such that the total attenuation of sound waves in all the propagation paths (P) is less than a predetermined value.

In setting the environment condition measurement device (1), the installation angle of each sound wave unit (10) may be fixed by a computer prepared separately from the controller (30) or by a server on a network.

While the embodiments and variations thereof have been described above, it will be understood that various changes in form and details may be made without departing from the spirit and scope of the claims. The foregoing embodiment and variations thereof may be combined or replaced with each other without deteriorating the intended functions of the present disclosure.

The expressions such as “first,” “second,” “third,” . . . , described above are used to distinguish the terms to which these expressions are given, and do not limit the number and order of the terms.

As can be seen from the foregoing description, the present disclosure is useful for an environment condition measurement device and a method for setting an environment condition measurement device.

1. An environment condition measurement device comprising:
a plurality of sound wave units installed on a periphery of a measurement target space,
the sound wave units being located on a perimeter of each of a plurality of boundary planes virtually defining the measurement target space,
the plurality of sound wave units including
a transmission unit configured to transmit a sound wave directionally and
a reception unit configured to receive a sound wave directionally,
the environment condition measurement device being configured to measure an environment condition in the measurement target space based on propagation characteristics of the sound wave that propagates between the transmission unit and the reception unit,
at least one of the sound wave units being installed in an orientation in which a directivity axis exhibiting a maximum intensity of a directivity of transmission or reception is inclined at a predetermined angle with respect to at least one of the boundary planes at which the at least one of the sound wave units is located.

2. The environment condition measurement device of claim 1, wherein
the sound wave units are arranged at corner portions of the measurement target space, and
the sound wave units located at the corner portions of the measurement target space are each installed in an orientation in which the directivity axis is inclined at a predetermined angle with respect to each of the plurality of boundary planes forming the corner portion.

3. The environment condition measurement device of claim 1, wherein
the predetermined angle is set based on an attenuation of the sound wave for each propagation path associated with the sound wave unit.

4. The environment condition measurement device of claim 3, wherein
the attenuation of the sound wave is calculated based on
a directivity of transmission and a directivity of reception with respect to the propagation path and
a distance attenuation between the transmission unit and the reception unit associated with the propagation path.

5. The environment condition measurement device of claim 1, wherein
angles of the directivity axes of the plurality of sound wave units located on the perimeter of a same boundary plane with respect to the same boundary plane are set to be a same angle.

6. The environment condition measurement device of claim 1, wherein
the sound wave units are arranged at corner portions of the measurement target space, and
a pair of the sound wave units located at adjacent ones of the corner portions of the measurement target space on the perimeter of a same boundary plane are installed in orientations in line symmetry with respect to a virtual reference line passing through an intermediate position between the pair of the sound wave units as viewed in a direction orthogonal to the same boundary planes.

7. The environment condition measurement device of claim 1, wherein
the plurality of boundary planes include a first boundary plane and a second boundary plane, the first and second boundary planes facing each other,
each of a pair of the sound wave units located at positions on the first boundary plane and the second boundary plane corresponding to each other includes
a transmission element configured to implement a function of the transmission unit and
a reception element configured to implement a function of the reception unit as separate elements, and
the pair of the sound wave units are installed in orientations so that a positional relationship of the transmission element and the reception element relative to a virtual reference plane defined at an intermediate position between the first boundary plane and the second boundary plane is the same.

8. A method for setting an environment condition measurement device including a plurality of sound wave units including a transmission unit configured to transmit a sound wave directionally, and a reception unit configured to receive a sound wave directionally, the plurality of sound wave units being installed apart from each other to form a plurality of boundary planes having the sound wave units on perimeters of the boundary planes, and the boundary planes defining a measurement target space, the method comprising:
calculating an attenuation of the sound wave for each propagation path of the sound wave associated with at least one of the sound wave units, based on
a directivity of transmission and a directivity of reception with respect to the propagation path and
a distance attenuation between the transmission unit and the reception unit; and
determining, based on the attenuation of the sound wave for each of the propagation paths, an angle of a directivity axis
exhibiting a maximum intensity of a directivity of transmission or reception of the at least one of the sound wave units in an installation orientation, and
inclining with respect to at least one of the boundary planes at which the at least one of the sound wave units are located.

9. The environment condition measurement device of claim 2, wherein
the predetermined angle is set based on an attenuation of the sound wave for each propagation path associated with the sound wave unit.

10. The environment condition measurement device of claim 9, wherein
the attenuation of the sound wave is calculated based on
a directivity of transmission and a directivity of reception with respect to the propagation path and
a distance attenuation between the transmission unit and the reception unit associated with the propagation path.

11. The environment condition measurement device of claim 2, wherein
angles of the directivity axes of the plurality of sound wave units located on the perimeter of a same boundary plane with respect to the same boundary plane are set to be a same angle.

12. The environment condition measurement device of claim 2, wherein
the sound wave units are arranged at corner portions of the measurement target space, and
a pair of the sound wave units located at adjacent ones of the corner portions of the measurement target space on the perimeter of a same boundary plane are installed in orientations in line symmetry with respect to a virtual reference line passing through an intermediate position between the pair of the sound wave units as viewed in a direction orthogonal to the same boundary planes.

13. The environment condition measurement device of claim 2, wherein
the plurality of boundary planes include a first boundary plane and a second boundary plane, the first and second boundary planes facing each other,
each of a pair of the sound wave units located at positions on the first boundary plane and the second boundary plane corresponding to each other includes
a transmission element configured to implement a function of the transmission unit and
a reception element configured to implement a function of the reception unit as separate elements, and
the pair of the sound wave units are installed in orientations so that a positional relationship of the transmission element and the reception element relative to a virtual reference plane defined at an intermediate position between the first boundary plane and the second boundary plane is the same.
